(19) United States
(12) Patent Application Publication
(10) Pub. No.: US 2025/0188387 A1
(43) Pub. Date: Jun. 12, 2025

(54) LOW TOXICITY SURFACTANT BOOSTER COMPOSITIONS FOR FILTRATION MEMBRANE CLEANING APPLICATIONS

(71) Applicant: ECOLAB USA INC., Saint Paul, MN (US)

(72) Inventors: Krista Otting, Bloomington, MN (US); Sukhwan Soontravanich, Inver Grove Heights, MN (US); Stephan Doerries, Düsseldorf (DE); Matthias Schmitz, Düsseldorf (DE); Ralf Krack, Hilden (DE)

(21) Appl. No.: 18/972,360

(22) Filed: Dec. 6, 2024

Related U.S. Application Data
(60) Provisional application No. 63/607,718, filed on Dec. 8, 2023.

(51) Int. Cl. C11D 1/825; B01D 65/02; C11D 1/66; C11D 1/76; C11D 3/33; C11D 3/386

(52) U.S. Cl. CPC C11D 1/825; B01D 65/02; C11D 3/33; C11D 3/38618; C11D 3/38627; B01D 2321/162; B01D 2321/166; B01D 2321/168; C11D 1/662; C11D 1/76

(57) ABSTRACT

Disclosed herein are surfactant booster compositions for filtration membrane cleaning, multi-part detergents comprising the surfactant booster compositions, an enzyme composition, and alkalinity composition. Further disclosed are methods of cleaning filtration membranes with the aforementioned compositions and system. Beneficially, the surfactant booster compositions have low toxicity with high butterfat removal capacity. The compositions and methods are suitable for filtration membranes including microfiltration, ultrafiltration, nanofiltration, and reverse osmosis membranes.

### CROSS-REFERENCE

This is a Continuation Application of, and claims priority under 35 U.S.C. § 119 to, U.S. Provisional Application Ser. No. 63/607,718 filed on Dec. 8, 2023, entitled “LOW TOXICITY SURFACTANT BOOSTER COMPOSITIONS FOR FILTRATION MEMBRANE CLEANING APPLICATIONS”; which is expressly incorporated herein by reference.

### TECHNICAL FIELD

This disclosure relates generally to the field of filtration membrane cleaning and in particular to surfactant booster compositions suitable for food and beverage membrane cleaning applications. In particular, the surfactant booster compositions provide a high performing fat removal agent with low toxicity profile. The compositions and methods are suitable for filtration membranes including, but not limited to microfiltration, ultrafiltration, nanofiltration, and reverse osmosis membranes.

### BACKGROUND

As party of the dairy industry, membranes are employed to filter dairy products. The membranes can be used in a variety of steps with different intended separations. Regardless, of the separation step, the membranes become significantly soiled. It is necessary to regularly clean the membranes to remove organic and inorganic materials deposited on the surface of the membranes. To continue use of the membranes, it is critical that they be cleaned with materials that leave no residual taste or odor as food products are prepared from the dairy products filtered therethrough. Additionally, it is important that the materials used to clean the membranes are safe to use.

A critical challenge in dairy production is fat fouling in filtration membranes. Studies of cleaned and uncleaned field membranes showed a factor of 10 times higher fouling load of fats, especially high-melting triglycerides compared to protein foulants present on the membranes of globally sampled filtration membranes. Other filtration membranes used in food and beverage production, water filtration, and biotech separations also undergo dirtying and fouling with various soils. These can face similar challenges in cleaning.

Various cleaners are used to clean filtration membranes, some acidic, alkaline, neutral or enzymatic. Surfactant boosters can be used to aid the detergents; however, conventional surfactant boosters, which often comprise include ingredients that are increasingly recognized as environmentally toxic, such as nonyl-phenol ethoxylates (NPEs). Non-toxic surfactants have been identified (including, but not limited to, sugar-based surfactants); however, these typically have reduced performance. To accommodate with the lower performance, low toxicity surfactants often have to be used at higher concentrations than their counterpart surfactants typical to the industry. Additionally, the conventional surfactants are often only compatible in neutral to alkaline conditions, not acidic.

Accordingly, there is a need for filtration membrane cleaning compositions and methods to clean filtration membranes to overcome these downfalls of current clean-in-place filtration membrane cleaning regimes. This includes a need for low toxicity surfactant boosters that have high efficacy and preferably which are compatible with acidic detergents.

### BRIEF SUMMARY OF PREFERRED EMBODIMENTS

Disclosed herein are surfactant booster compositions for filtration membrane cleaning applications. The disclosure also provides for methods of manufacture and methods of using the surfactant booster compositions. The surfactant booster compositions provide various advantages over existing filtration membrane cleaning compositions and their surfactant packages. For example, the disclosed surfactant boosters exhibit low toxicity. Another advantage of the disclosed surfactant boosters is that they are compatible in acidic conditions. Other advantages and benefits of the disclosed methods are described herein.

A preferred embodiment comprises a low toxicity surfactant booster composition for filtration membrane cleaning comprising: from about 2% active to about 30% active of an C₄-C₂₄ alkyl polyglycoside; from about 5% active to about 60% active of an alkoxylated block copolymer; and from about 10 wt. % to about 40 wt. % water. Preferably, the surfactant booster composition has soil penetration efficacy against dairy soils comprising fats and proteins. The surfactant booster composition can optionally include a chelant, stabilizer, and/or enzyme.

A preferred embodiment comprises a low toxicity surfactant booster use solution for filtration membrane cleaning comprising: from about 5 ppm to about 10,000 ppm of an C₄-C₂₄ alkyl polyglycoside; from about 10 ppm to about 10,000 ppm of an alkoxylated block copolymer; and water. The surfactant booster use solution can optionally include a chelant, stabilizer, and/or enzyme.

A preferred embodiment comprises a method of cleaning a filtration membrane comprising: (a) contacting the filtration membrane with the surfactant booster use solution comprising: from about 5 ppm to about 10,000 ppm of an C₄-C₂₄ alkyl polyglycoside; from about 10 ppm to about 10,000 ppm of an alkoxylated block copolymer; and water; and

(b) rinsing the filtration membrane. The surfactant booster use solution can optionally include a chelant, stabilizer, and/or enzyme.

### BRIEF DESCRIPTION OF THE FIGURES

FIG. 1 displays the cleaning capabilities of block copolymers, block copolymer/APG combinations, and inline formulations under alkaline conditions. Additionally, photographs of the coupons are included with their respective columns.

FIG. 2 displays the cleaning capabilities of low doses of block copolymers, block copolymer/APG combinations, and a commercially available formulation as a control—each under alkaline conditions. Stoichiometric ratios are included for block copolymer/APG combinations.

FIG. 3 further displays the cleaning capabilities of block copolymers, block copolymer/APG combinations, and a commercially available formulation as a control; however, additional experimentation was conducted to assess possible surfactant use under acidic conditions.

FIG. 4 provides wettability comparisons between block copolymers, APGs, combinations thereof, and a commercially available formulation as a control. 95% confidence intervals are provided for the contact angles based on the mean contact angle.

FIG. 5 displays redeposition of ghee onto coupons for block copolymers, APGs, combinations thereof, and a commercially available formulation as a control.

Various embodiments of this disclosure are described with reference to the figures. Reference to Figures, and any embodiments disclosed therein, does not limit the scope of the invention. Figures represented herein are not limitations to the various embodiments according to the disclosure and are presented as examples and non-limiting embodiments of the inventions disclosed herein.

### DETAILED DESCRIPTION

The present disclosure relates to surfactant booster compositions, as well as, methods of manufacture use. Beneficially, the surfactant booster compositions have low toxicity. A further benefit is that they are compatible in acidic conditions. Still another advantage is that the surfactant boosters provide efficacy at low concentrations.

It is further to be understood that all terminology used herein is for the purpose of describing particular embodiments only, and is not intended to be limiting in any manner or scope. For example, as used in this specification and the appended claims, the singular forms “a,” “an” and “the” can include plural referents unless the content clearly indicates otherwise. Further, all units, prefixes, and symbols may be denoted in its SI accepted form.

Numeric ranges recited within the specification are inclusive of the numbers defining the range and include each integer within the defined range. Throughout this disclosure, various aspects of this invention are presented in a range format. It should be understood that the description in range format is merely for convenience and brevity and should not be construed as an inflexible limitation on the scope of the invention. Accordingly, the description of a range should be considered to have specifically disclosed all the possible sub-ranges, fractions, and individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6, and decimals and fractions, for example, 1.2, 3.8, 11/2, and 43/4. This applies regardless of the breadth of the range.

### Definitions

So that the present invention may be more readily understood, certain terms are first defined. Unless defined otherwise, all technical and scientific terms used herein have the same meaning as commonly understood by one of ordinary skill in the art to which embodiments of the invention pertain. Many methods and materials similar, modified, or equivalent to those described herein can be used in the practice of the embodiments of the present invention without undue experimentation, the preferred materials and methods are described herein. In describing and claiming the embodiments of the present invention, the following terminology will be used in accordance with the definitions set out below.

The term “about,” as used herein, refers to variation in the numerical quantity that can occur, for example, through typical measuring techniques and equipment, with respect to any quantifiable variable, including, but not limited to, concentration, mass, volume, time, temperature, and pH. Further, given solid and liquid handling procedures used in the real world, there is certain inadvertent error and variation that is likely through differences in the manufacture, source, or purity of the ingredients used to make the compositions or carry out the methods and the like. The term “about” also encompasses these variations. Whether or not modified by the term “about,” the claims include equivalents to the quantities.

The methods and compositions of the present invention may comprise, consist essentially of, or consist of the components and ingredients of the present invention as well as other ingredients described herein. As used herein, “consisting essentially of” means that the methods, systems, apparatuses and compositions may include additional steps, components or ingredients, but only if the additional steps, components or ingredients do not materially alter the basic and novel characteristics of the claimed methods, systems, apparatuses, and compositions.

The term “actives” or “percent actives” or “percent by weight actives” or “actives concentration” are used interchangeably herein and refers to the concentration of those ingredients involved in cleaning expressed as a percentage minus inert ingredients such as water or salts. It is also sometimes indicated by a percentage in parentheses, for example, “chemical (10%).”

As used herein, the term “alkyl” or “alkyl groups” refers to saturated hydrocarbons having one or more carbon atoms, including straight-chain alkyl groups (e.g., methyl, ethyl, propyl, butyl, pentyl, hexyl, heptyl, octyl, nonyl, decyl, etc.), cyclic alkyl groups (or “cycloalkyl” or “alicyclic” or “carbocyclic” groups) (e.g., cyclopropyl, cyclopentyl, cyclohexyl, cycloheptyl, cyclooctyl, etc.), branched-chain alkyl groups (e.g., isopropyl, tert-butyl, sec-butyl, isobutyl, etc.), and alkyl-substituted alkyl groups (e.g., alkyl-substituted cycloalkyl groups and cycloalkyl-substituted alkyl groups).

Unless otherwise specified, the term “alkyl” includes both “unsubstituted alkyls” and “substituted alkyls.” As used herein, the term “substituted alkyls” refers to alkyl groups having substituents replacing one or more hydrogens on one or more carbons of the hydrocarbon backbone. Such substituents may include, for example, alkenyl, alkynyl, halogeno, hydroxyl, alkylcarbonyloxy, arylcarbonyloxy, alkoxycarbonyloxy, aryloxy, aryloxycarbonyloxy, carboxylate, alkylcarbonyl, arylcarbonyl, alkoxycarbonyl, aminocarbonyl, alkylaminocarbonyl, dialkylaminocarbonyl, alkylthiocarbonyl, alkoxyl, phosphate, phosphonato, phosphinato, cyano, amino (including alkyl amino, dialkylamino, arylamino, diarylamino, and alkylarylamino), acylamino (including alkylcarbonylamino, arylcarbonylamino, carbamoyl and ureido), imino, sulfhydryl, alkylthio, arylthio, thiocarboxylate, sulfates, alkylsulfinyl, sulfonates, sulfamoyl, sulfonamido, nitro, trifluoromethyl, cyano, azido, heterocyclic, alkylaryl, or aromatic (including heteroaromatic) groups.

In some embodiments, substituted alkyls can include a heterocyclic group. As used herein, the term “heterocyclic group” includes closed ring structures analogous to carbocyclic groups in which one or more of the carbon atoms in the ring is an element other than carbon, for example, nitrogen, sulfur or oxygen. Heterocyclic groups may be saturated or unsaturated. Exemplary heterocyclic groups include, but are not limited to, aziridine, ethylene oxide (epoxides, oxiranes), thiirane (episulfides), dioxirane, azetidine, oxetane, thietane, dioxetane, dithietane, dithiete, azolidine, pyrrolidine, pyrroline, oxolane, dihydrofuran, and furan.

As used herein, the term “antimicrobial” refers to a compound or composition that reduces and/or inactivates a microbial population, including, but not limited to bacteria, viruses, fungi, and algae within about 10 minutes or less, about 8 minutes or less, about 5 minutes or less, about 3 minutes or less, about 2 minutes or less, about 1 minute or less, or about 30 seconds or less. Preferably, the term antimicrobial refers to a composition that provides at least about a 3-log, 3.5 log, 4 log, 4.5 log, or 5 log reduction of a microbial population in about 10 minutes or less, about 8 minutes or less, about 5 minutes or less, about 3 minutes or less, about 2 minutes or less, about 1 minute or less, or about 30 seconds or less.

As used herein, the term “cleaning” refers to a method used to facilitate or aid in soil removal, bleaching, microbial population reduction, and any combination thereof. As used herein, the term “microorganism” refers to any noncellular or unicellular (including colonial) organism. Microorganisms include all prokaryotes. Microorganisms include bacteria (including cyanobacteria), spores, lichens, fungi, protozoa, virinos, viroids, viruses, phages, and some algae. As used herein, the term “microbe” is synonymous with microorganism.

As used herein, the term “exemplary” refers to an example, an instance, or an illustration, and does not indicate a most preferred embodiment unless otherwise stated.

As used herein, the phrase “food processing surface” refers to a surface of a tool, a machine, equipment, a structure, a building, or the like that is employed as part of a food processing, preparation, or storage activity. Examples of food processing surfaces include surfaces of food processing or preparation equipment (e.g., slicing, canning, or transport equipment, including flumes), of food processing wares (e.g., utensils, dishware, wash ware, and bar glasses), and of floors, walls, or fixtures of structures in which food processing occurs. Food processing surfaces are found and employed in food anti-spoilage air circulation systems, aseptic packaging sanitizing, food refrigeration and cooler cleaners and sanitizers, ware washing sanitizing, blancher cleaning and sanitizing, food packaging materials, cutting board additives, third-sink sanitizing, beverage chillers and warmers, meat chilling or scalding waters, autodish sanitizers, sanitizing gels, cooling towers, food processing antimicrobial garment sprays, and non-to-low-aqueous food preparation lubricants, oils, and rinse additives.

The term “generally” encompasses both “about” and “substantially.”

The term “hard surface” refers to a solid, substantially non-flexible surface such as a counter top, tile, floor, wall, panel, window, plumbing fixture, kitchen and bathroom furniture, appliance, engine, circuit board, dish, mirror, window, monitor, touch screen, and thermostat. Hard surfaces are not limited by the material; for example, a hard surface can be glass, metal, tile, vinyl, linoleum, composite, wood, plastic, etc. Hard surfaces may include for example, health care surfaces and food processing surfaces.

The term “low toxicity” as used herein refers to a composition and/or any ingredient in the composition that has a derived no-effect level (DNEL) of above about 20. As referred to herein, a DNEL is substance specific and is commonly used as a health risk-based threshold in toxicological risk assessments. As a point of departure for the derivation of a DNEL varying toxicological studies are used, supplied by the surfactant manufacturer. Depending on the origin of the study this data is either publicly available or subject of confidentiality of an organization. Depending on evaluated endpoint and different parameters of these studies certain assessment factors are applied to derivate the DNEL. Used herein are scientifically justified and publicly recognized methods (e.g. by EFSA or ECETOC) for the determination of these assessment factors.

As used herein, the terms “membrane” and “filtration membrane”, refer to membranes used in the filtration of food and beverage products including, but not limited to, brewing, dairy, and juices; water filtration; and biotech filtration. Such membranes include, but are not limited to, microfiltration membranes, ultrafiltration membranes, nanofiltration membranes, and reverse osmosis membranes.

As used herein, the term “microorganism” refers to any noncellular or unicellular (including colonial) organism. Microorganisms include all prokaryotes. Microorganisms include bacteria (including cyanobacteria), spores, lichens, fungi, protozoa, virinos, viroids, viruses, phages, and some algae. As used herein, the term “microbe” is synonymous with microorganism.

As used herein the term “polymer” refers to a molecular complex comprised of a more than ten monomeric units and generally includes, but is not limited to, homopolymers, copolymers, such as for example, block, graft, random and alternating copolymers, terpolymers, and higher “x”mers, further including their analogs, derivatives, combinations, and blends thereof. Furthermore, unless otherwise specifically limited, the term “polymer” shall include all possible isomeric configurations of the molecule, including, but are not limited to isotactic, syndiotactic and random symmetries, and combinations thereof. Furthermore, unless otherwise specifically limited, the term “polymer” shall include all possible geometrical configurations of the molecule.

The “scope” of the present invention is defined by the appended claims, along with the full scope of equivalents to which such claims are entitled. The scope of the invention is further qualified as including any possible modification to any of the aspects and/or embodiments disclosed herein which would result in other embodiments, combinations, subcombinations, or the like that would be obvious to those skilled in the art.

As used herein, the term “soil” or “stain” refers to any soil, including, but not limited to, non-polar oily and/or hydrophobic substances which may or may not contain particulate matter such as industrial soils, mineral clays, sand, natural mineral matter, carbon black, graphite, kaolin, environmental dust, and/or food based soils such as blood, proteinaceous soils, starchy soils, fatty soils, cellulosic soils, etc.

The term “substantially” refers to a great or significant extent. “Substantially” can thus refer to a plurality, majority, and/or a supermajority of said quantifiable variable, given proper context.

As used herein, the term “substantially free” refers to compositions completely lacking the component or having such a small amount of the component that the component does not affect the performance of the composition. The component may be present as an impurity or as a contaminant and shall be less than 0.5 wt-%. In another embodiment, the amount of the component is less than 0.1 wt-% and in yet another embodiment, the amount of component is less than 0.01 wt-%.

The term “surfactant” or “surface active agent” refers to an organic chemical that when added to a liquid changes the properties of that liquid at a surface.

As used herein, the term “unit dose solid” refers to a composition unit sized so that the entire unit is used during a single cleaning cycle. When the solid hard surface cleaning composition is provided as a unit dose, it is preferably provided as a pressed solid, cast solid, an extruded pellet, or a tablet having a size of between approximately 1 gram and approximately 50 grams.

As used herein, the term “ware” refers to items such as eating and cooking utensils, dishes, and other hard surfaces such as showers, sinks, toilets, bathtubs, countertops, windows, mirrors, transportation vehicles, and floors. As used herein, the term “warewashing” refers to washing, cleaning, or rinsing ware. Ware also refers to items made of plastic. Types of plastics that can be cleaned with the compositions according to the invention include but are not limited to, those that include polypropylene polymers (PP), polycarbonate polymers (PC), melamine formaldehyde resins or melamine resin (melamine), acrylonitrile-butadiene-styrene polymers (ABS), and polysulfone polymers (PS). Other exemplary plastics that can be cleaned using the compounds and compositions of the invention include polyethylene terephthalate (PET) polystyrene polyamide.

The term “weight percent,” “wt-%,” “percent by weight,” “% by weight,” and variations thereof, as used herein, refer to the concentration of a substance as the weight of that substance divided by the total weight of the composition and multiplied by 100. It is understood that, as used here, “percent,” “%,” and the like are intended to be synonymous with “weight percent,” “wt-%,” etc.

### Surfactant Booster Compositions

Disclosed herein are surfactant booster composition for filtration membrane cleaning. The surfactant boosters can be added alongside a detergent composition or as an independent step in a filtration membrane cleaning process. The surfactant boosters can also be included in a detergent composition or cleaning system. Beneficially, the surfactant boosters exhibit low toxicity. An additional advantage of the surfactant booster compositions is that they are compatible in alkaline, neutral, and acidic conditions; thus, they are compatible with a variety of cleaning processes and detergents.

According to embodiments, the surfactant booster compositions comprise an alkyl polyglycoside, a block copolymer, and water. Exemplary surfactant booster compositions are provided in Tables 1A-1B. While the components may have a percent active of 100%, it is noted that Tables 1A-1B do not recite the percent actives of certain optional functional ingredients, but rather, recite the total weight percentage of the raw materials (i.e. active concentration plus inert ingredients).

TABLE 1A
Concentrated Surfactant Booster Compositions

| | | Second | Third |
|---|---|---|---|
| | First Exemplary | Exemplary | Exemplary |
| Material | Range % | Range % | Range % |
| alkyl polyglycoside | 2-30 | 2-20 | 5-20 |
| (active) | | | |
| alkoxylated block | 5-60 | 10-55 | 15-50 |
| copolymer (active) | | | |
| Water | 20-70 | 25-60 | 35-70 |
| Optional Functional | 0.001-30 | 0.001-30 | 0.001-30 |
| Ingredients (if included) | | | |

TABLE 1B
Surfactant Booster Use Solutions

| | First | Second | Third |
|---|---|---|---|
| | Exemplary | Exemplary | Exemplary |
| Material | Range ppm | Range ppm | Range ppm |
| alkyl polyglycoside | 5-10,000 | 20-1000 | 30-500 |
| alkoxylated block | 10-10,000 | 50-1000 | 100-750 |
| copolymer | | | |
| Water | Q.S. | Q.S. | Q.S. |
| Optional Functional | 0-1000 | 1-500 | 5-250 |
| Ingredients | | | |
| Optional Enzyme | 0-50 | 1-37.5 | 0.001-20 |
| (active) | | | |
| Optional Chelant (active) | 0-1500 | 1-750 | 0.01-400 |
| Optional Stabilizer | 0-1000 | 0-750 | 0-500 |
| pH (acid composition) | 1.5-3 | 1.8-2.5 | 1.8-2.0 |
| pH (alkaline | 10-11 | 10.5-11 | 10.8-11 |
| composition) with | | | |
| Membrane limit pH 11 | | | |
| pH (alkaline | 11-11.5 | 11.2-11.5 | 11.3-11.5 |
| composition) with | | | |
| Membrane limit pH 11.5 | | | |

The surfactant booster compositions are liquid concentrates that are diluted to form use solutions. In general, a concentrate refers to a composition that is intended to be diluted with water to provide a use solution that contacts an object to provide the desired cleaning, sanitizing, or the like. The surfactant booster composition that contacts the membranes to be cleaned can be referred to as a concentrate or a use solution depending on the formulation employed in methods. It should be understood that the concentration of the components in the surfactant booster compositions will vary depending on the concentrated nature of the formulation and the desired concentration at use.

In some embodiments, a ready-to-use solution of the surfactant booster concentrate diluted to form a use composition is shelf stable, or has a shelf-life, of one day, or more than one day, or more than one week, or more than two weeks. In an embodiment, the ready-to-use diluted form of the solid compositions have a shelf-life of about two weeks.

The surfactant booster compositions are suitable for use in acidic and alkaline conditions. Accordingly, the surfactant booster compositions can be used alongside an alkaline detergent that provides a pH of from about 8 to about 14, from about 8.5 to about 13, from about 9 to about 12, from about 9.5 to about 11.5, from about 10 to about 11, from about 10.5 to about 11, from about 10.8 to about 11, from about 11 to about 11.5, from about 11.2 to about 11.5, from about 11.3 to about 11.5. Accordingly, the surfactant booster compositions can be used alongside an acidic detergent that provides a pH of from about 1 to about 5, from about 1.2 to about 4.5, from about 1.3 to about 4, from about 1.4 to about 3.5, from about 1.5 to about 3, from about 1.8 to about 2.5, from about 1.8 to about 2.

The surfactant booster compositions are preferably diluted to form a use solution. Preferably, the diluting step is performed at a dilution ratio of between about 1/32 oz/gal and about 4 oz/gal. The use solution preferably has a diluted concentration of less than about 10,000 ppm, less than about 9500 ppm, less than about 9000 ppm, less than about 8500 ppm, less than about 8000 ppm, less than about 7500 ppm, less than about 7000 ppm, less than about 6500 ppm, less than about 6000 ppm, less than about 5500 ppm, less than about 5000 ppm, less than about 4500 ppm, less than about 4000 ppm, less than about 3500 ppm, less than about 3000 ppm, less than about 2500 ppm, less than about 2000 ppm, less than about 1500 ppm, less than about 1000 ppm, less than about 900 ppm, less than about 850 ppm, less than about 800 ppm, less than about 750 ppm, less than about 700 ppm, less than about 650 ppm, less than about 600 ppm, less than about 550 ppm, less than about 500 ppm.

Preferably, the total concentration of surfactant in a use solution from the surfactant booster (some detergents also include a surfactant) is from about 150 ppm to about 1000 ppm, more preferably from about 200 ppm to about 800 ppm.

### Alkyl Polyglycoside

The surfactant booster compositions comprise an alkyl polyglycoside. Without being limited to a particular method or theory, alkyl polyglycosides help prevent redeposition of soils thereby contributing to the cleaning efficacy of the booster composition.

Preferred alkyl polyglycosides have an alkyl chain length of from about 4 carbons to about 24 carbons, more preferably about 6 carbons to about 20 carbons, most preferably from about 8 carbons to about 16 carbons. Thus, preferably the surfactant booster comprises a C₄-C₂₄ alkyl polyglycoside, more preferably a C₆-C₂₀ alkyl polyglycoside, most preferably a C₈-C₁₆ alkyl polyglycoside.

The alkyl polyglycoside is present in the surfactant booster composition in a concentration of from about 2% active to about 30% active, about 2% active to about 20% active, about 5% active to about 20% active, about 10% active to about 20% active, or from about 5% active to about 10% active. In a use solution, the alkyl polyglycoside is preferably in an amount less than about 10,000 ppm, less than about 9500 ppm, less than about 9000 ppm, less than about 8500 ppm, less than about 8000 ppm, less than about 7500 ppm, less than about 7000 ppm, less than about 6500 ppm, less than about 6000 ppm, less than about 5500 ppm, less than about 5000 ppm, less than about 4500 ppm, less than about 4000 ppm, less than about 3500 ppm, less than about 3000 ppm, less than about 2500 ppm, less than about 2000 ppm, less than about 1500 ppm, less than about 1000 ppm, less than about 900 ppm, less than about 850 ppm, less than about 800 ppm, less than about 750 ppm, less than about 700 ppm, less than about 650 ppm, less than about 600 ppm, less than about 550 ppm, less than about 500 ppm, less than about 450 ppm, less than about 400 ppm, less than about 350 ppm. In a use solution, the alkyl polyglycoside is preferably in a concentration of at least about 5 ppm, at least about 10 ppm, at least about 20 ppm, at least about 30 ppm, at least about 40 ppm, at least about 50 ppm, at least about 60 ppm, at least about 70 ppm, at least about 80 ppm, at least about 90 ppm, at least about 100 ppm. Preferably in use solution the alkyl polyglycoside is in a concentration of from about 5 ppm to about 10,000 ppm, or from about 20 ppm to about 1000 ppm, or from about 30 ppm to about 500 ppm.

### Alkoxylated Block Copolymer

The surfactant booster compositions comprise an alkoxylated block copolymer. Preferred alkoxylated block copolymers include EO-PO copolymers, capped EO-PO copolymers, reverse block copolymers, tetra-functioanl block copolymers, and mixtures thereof. Preferred alkoxylated block copolymers include Pluronic and reverse Pluronic surfactants.

Block polyoxypropylene-polyoxyethylene polymeric compounds based upon propylene glycol, ethylene glycol, glycerol, trimethylolpropane, and ethylenediamine as the initiator reactive hydrogen compound. Examples of polymeric compounds made from a sequential propoxylation and ethoxylation of initiator are commercially available under the trade names Pluronic® and Tetronic® manufactured by BASF Corp. Such compounds can include, by way of example, an EO/PO capped alkoxylated glycerol, wherein the EO groups are between 25 wt. % and 50 wt. % of the surfactant, more preferably between about 30 wt. % and about 50 wt. % of the surfactant. Pluronic® compounds are difunctional (two reactive hydrogens). Tetronic® compounds are tetra-functional block copolymers. Reverse polyoxyalkylene block copolymer(s) (also known as alkoxylated block copolymer(s)). A preferred alkoxylated block copolymer

(EO)ₓ-(PO)ₓ-(EO)ₓ

where x is from about 1 to 1000, preferably about 4 to 500, and y is from about 1 to 500, preferably about 2 to 250.

The polyoxyalkylene block copolymers useful in the surfactant booster compositions can be formed by reacting alkylene oxides with initiators. Preferably, the initiator is multifunctional because of its use results in “multibranch” or “multiarm” block copolymers. For example, propylene glycol (bifunctional), triethanol amine (trifunctional), and ethylenediamine (tetrafunctional) can be used as initiators to initiate polymerization of ethylene oxide and propylene oxide to produce reverse block copolymers with two branches (i.e., arms or linear units of polyoxyalkylenes), three branches, and four branches, respectively. Such initiators may contain carbon, nitrogen, or other atoms to which arms or branches, such as blocks of polyoxyethylene (EO)ₑ, polyoxypropylene (PO)ₚ, polyoxybutylene (BO)_{b}, -(EO)ₑ-(PO)ₚ, -(EO)ₑ-(BO)_{b}, or -(EO) 3-(PO)ₚ-(BO)_{b}, can be attached. Preferably, the reverse block copolymer has arms or chains of polyoxyalkylenes that are attached to the residues of the initiators contain end blocks of -(EO)ₓ-(PO)_{y}, which have ends of polyoxypropylene (i.e., -(PO)_{y}), wherein x is about 1 to 1000 and y is about 1 to 500, more preferably x is about 5 to 20 and y is about 5 to 20.

The reverse block copolymer can be a straight chain, such as a three-block copolymer,

(PO)_{y}-(EO)ₓ-(PO)_{y}

where x is about 1 to 1000, preferably about 4 to 230; and y is about 1 to 500, preferably about 8 to 27. Such a copolymer can be prepared by using propylene glycol as an initiator and adding ethylene oxide and propylene oxide. The polyoxyalkylene blocks are added to both ends of the initiator to result in the block copolymer. In such a linear block copolymer, generally the central (EO)ₓ contains the residue of the initiator and x represents the total number of EO on both sides of the initiator. Generally, the residue of the initiator is not shown in a formula such as the three-block copolymer above because it is insignificant in size and in contribution to the property of the molecule compared to the polyoxyalkylene blocks. Likewise, although the end block of the polyoxyalkylene block copolymer terminates in a —OH group, the end block is represented by -(PO)ₚ, -(EO)ₓ, -(PO)_{y}, and the like, without specifically showing the —OH at the end. Also, x, y, and z are statistical values representing the average number of monomer units in the blocks.

The reverse polyoxyalkylene block copolymer can have more than three blocks, an example of which is a five-block copolymer,

(PO)_{z}-(EO)_{y}-(PO)ₓ-(EO)_{y}-(PO)_{z}

where x is about 1 to 1,000, preferably about 7 to 21; y is about 1 to 500, preferably about 10 to 20; and z is about 1 to 500, preferably about 5 to 20.

A chain of blocks may have an odd or even number of blocks. Also, in other embodiments, copolymers with more blocks, such as, six, seven, eight, and nine blocks, etc., may be used as long as the end polyoxyalkylene block is either (PO)ₚ or (BO)_{b}. As previously stated, the reverse -(EO)ₑ-(PO)ₚ block copolymer can also have a branched structure having a trifunctional moiety T, which can be the residue of an initiator. The block copolymer is represented by the formula:

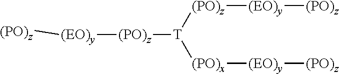

where x is about 0 to 500, preferably about 0 to 10; y is about 1 to 500, preferably about 5 to 12, and z is about 1 to 500, preferably about 5 to 10.

Preferred nonionic surfactants include, but are not limited to, Pluronic surfactants having (EO)(PO)(EO) structure, reverse Pluronic surfactant having (PO)(EO)(PO) structure and an average molecular weight of between about 500 g/mole and about 5000 g/mole, more preferably between about 1000 g/mole and about 4500 g/mole, most preferably between about 1500 g/mole and about 4000 g/mole.

The alkoxylated block copolymer is present in the surfactant booster composition in a concentration of from about 5% active to about 60% active, about 10% active to about 55% active, or from about 15% active to about 50% active. In a use solution, the alkoxylated block copolymer is preferably in an amount less than about 10,000 ppm, less than about 9500 ppm, less than about 9000 ppm, less than about 8500 ppm, less than about 8000 ppm, less than about 7500 ppm, less than about 7000 ppm, less than about 6500 ppm, less than about 6000 ppm, less than about 5500 ppm, less than about 5000 ppm, less than about 4500 ppm, less than about 4000 ppm, less than about 3500 ppm, less than about 3000 ppm, less than about 2500 ppm, less than about 2000 ppm, less than about 1500 ppm, less than about 1000 ppm, less than about 900 ppm, less than about 850 ppm, less than about 800 ppm, less than about 750 ppm, less than about 700 ppm, less than about 650 ppm, less than about 600 ppm, less than about 550 ppm, less than about 500 ppm, less than about 450 ppm, less than about 400 ppm, less than about 350 ppm. In a use solution, the alkoxylated block copolymer is preferably in a concentration of at least about 10 ppm, at least about 20 ppm, at least about 30 ppm, at least about 40 ppm, at least about 50 ppm, at least about 60 ppm, at least about 70 ppm, at least about 80 ppm, at least about 90 ppm, at least about 100 ppm. Preferably in use solution the alkoxylated block copolymer is in a concentration of from about 10 ppm to about 10,000 ppm, or from about 50 ppm to about 1000 ppm, or from about 100 ppm to about 750 ppm.

### Water

The surfactant booster compositions also include water. The water is preferably in an amount of from about 10 wt. % to about 70 wt. %, more preferably from about 15 wt. % to about 60 wt. %, most preferably from about 35 wt. % to about 70 wt. %. The water can be from any suitable source and is preferably low hardness. Preferred water includes water having a hardness of less than 15 grain, less than 10 grain, less than 9 grain, less than 8 grain, less than 7 grain, less than 6 grain, less than 5 grain. Preferred water can be tap water, distilled water, reverse osmosis water, or another water source.

### Optional Additional Functional Ingredients

The surfactant booster compositions can optionally include one or more functional ingredients. If included, optional functional ingredients preferably are low toxicity. Preferably the surfactant booster compositions are free of a fragrance, odorant, dye, and colorant.

Chelant and/or Sequestrant

The surfactant booster compositions can optionally comprise a chelant and/or sequestrant. As described herein, chelants include compounds that form water soluble complexes with metals. As described herein, sequestrants include compounds that form water insoluble complexes with metals.

Preferred chelants include aminocarboxylates, sodium tripolyphosphate, citrate (in their acid or salt form). Preferred aminocarboxylates include biodegradable aminocarboxylates. Examples of suitable biodegradable aminocarboxylates include: ethanoldiglycine, e.g., an alkali metal salt of ethanoldiglycine, such as disodium ethanoldiglycine (Na₂EDG); methylgylcinediacetic acid (MGDA), e.g., an alkali metal salt of methylgylcinediacetic acid, such as trisodium methylgylcinediacetic acid; ethylenediaminetetraacetic acid (EDTA); iminodisuccinic acid, e.g., an alkali metal salt of iminodisuccinic acid, such as iminodisuccinic acid sodium salt; N,N-bis-(carboxylatomethyl)-L-glutamic acid (GLDA), e.g., an alkali metal salt of N,N-bis(carboxylatomethyl)-L-glutamic acid, such as iminodisuccinic acid sodium salt (GLDA-Na₄); [S—S]-ethylenediaminedisuccinic acid (EDDS), e.g., an alkali metal salt of [S—S]-ethylenediaminedisuccinic acid, such as a sodium salt of [S—S]-ethylenediaminedisuccinic acid; 3-hydroxy-2,2′-iminodisuccinic acid (HIDS), e.g., an alkali metal salt of 3-hydroxy-2,2′-iminodisuccinic acid, such as tetrasodium 3-hydroxy-2,2′-iminodisuccinate.

Some examples of polymeric polycarboxylates suitable for use as sequestering agents include those having a pendant carboxylate (—CO₂) groups and include, for example, polyacrylic acid, maleic/olefin copolymer, acrylic/maleic copolymer, polymethacrylic acid, acrylic acid-methacrylic acid copolymers, hydrolyzed polyacrylamide, hydrolyzed polymethacrylamide, hydrolyzed polyamide-methacrylamide copolymers, hydrolyzed polyacrylonitrile, hydrolyzed polymethacrylonitrile, hydrolyzed acrylonitrile-methacrylonitrile copolymers, and the like.

If included, the chelant and/or sequestrant is preferably in a concentration between about 0.001 ppm and about 15000 ppm, more preferably between about 0.001 ppm and about 750 ppm, most preferably between about 50 ppm and about 400 ppm.

### Stabilizer

The surfactant booster compositions can optionally comprise a stabilizer for cold temperature resistance. Preferred stabilizers include, but are not limited to, glycerin, propylene glycol, or a mixture thereof.

If included, the stabilizer is preferably in a concentration between about 5 wt. % to about 30 wt. %; more preferably from about 7 wt. % to about 25 wt. % in concentrated form; in use solution from about 0.001 ppm and about 10,000 ppm, more preferably between about 0.1 ppm and about 5,000 ppm.

### Multi-Part Systems

The surfactant booster compositions can be a component in a multi-part cleaning system which includes an enzyme composition as a second part; the enzyme composition preferably comprises a buffer. An alkaline detergent can also be included as a third part. Alternatively, the alkaline detergent can be included in the surfactant booster or the enzyme composition (dependent upon the enzyme's pH stability).

### Enzyme Composition

The enzyme composition preferably comprises an amylase, a cellulase, a lipase, a protease, a cutinase, a peroxidase, a gluconase, or DNAse, or other dairy soil digesting enzymes also mixtures thereof; and optionally a buffer, chelant, and/or sequestrant.

Any lipase or mixture of lipases, from any source, can be used in the enzyme composition, provided that the selected lipase is stable in a pH range compatible with the type of membrane. For example, the lipase enzymes can be derived from a plant, an animal, or a microorganism such as a fungus or a bacterium. The lipase can be purified or a component of a microbial extract, and either wild type or variant (either chemical or recombinant).

The enzyme composition can further comprise a protease. Any protease or mixture of proteases, from any source, can be used in the enzyme composition, provided that the selected protease is stable in a pH range compatible with the type of membrane. For example, the protease enzymes can be derived from a plant, an animal, or a microorganism such as a yeast, a mold, or a bacterium. Preferred protease enzymes include, but are not limited to, the enzymes derived from Bacillus subtilis, Bacillus licheniformis and Streptomyces griseus. Protease enzymes derived from B. subtilis are most preferred. The protease can be purified or a component of a microbial extract, and either wild type or variant (either chemical or recombinant).

The enzyme composition comprises a buffer. Preferably the buffer is selected based on the optimal pH for the enzyme(s) in the enzyme composition. Preferred buffers include those suitable for buffering the composition such that it maintains a pH between 7.5 and 12.5. Any suitable buffer achieving this pH can be utilized. In a preferred embodiment, the buffer comprises a carbonate-based buffer, including, but not limited to an alkali metal carbonate, sodium bicarbonate, or a mixture thereof. The amount of buffer included is the amount needed to retain a pH for optimal enzyme activity.

The enzyme composition can optionally comprise a chelant and/or sequestrant. As described herein, chelants include compounds that form water soluble complexes with metals. As described herein, sequestrants include compounds that form water insoluble complexes with metals.

Preferred chelants include aminocarboxylates, sodium tripolyphosphate, citrate (in their acid or salt form). Preferred aminocarboxylates include biodegradable aminocarboxylates. Examples of suitable biodegradable aminocarboxylates include: ethanoldiglycine, e.g., an alkali metal salt of ethanoldiglycine, such as disodium ethanoldiglycine (Na₂EDG); methylgylcinediacetic acid (MGDA), e.g., an alkali metal salt of methylgylcinediacetic acid, such as trisodium methylgylcinediacetic acid; ethylenediaminetetraacetic acid (EDTA); iminodisuccinic acid, e.g., an alkali metal salt of iminodisuccinic acid, such as iminodisuccinic acid sodium salt; N,N-bis-(carboxylatomethyl)-L-glutamic acid (GLDA), e.g., an alkali metal salt of N,N-bis(carboxylatomethyl)-L-glutamic acid, such as iminodisuccinic acid sodium salt (GLDA-Na₄); [S—S]-ethylenediaminedisuccinic acid (EDDS), e.g., an alkali metal salt of [S—S]-ethylenediaminedisuccinic acid, such as a sodium salt of [S—S]-ethylenediaminedisuccinic acid; 3-hydroxy-2,2′-iminodisuccinic acid (HIDS), e.g., an alkali metal salt of 3-hydroxy-2,2′-iminodisuccinic acid, such as tetrasodium 3-hydroxy-2,2′-iminodisuccinate.

Some examples of polymeric polycarboxylates suitable for use as sequestering agents include those having a pendant carboxylate (—CO₂) groups and include, for example, polyacrylic acid, maleic/olefin copolymer, acrylic/maleic copolymer, polymethacrylic acid, acrylic acid-methacrylic acid copolymers, hydrolyzed polyacrylamide, hydrolyzed polymethacrylamide, hydrolyzed polyamide-methacrylamide copolymers, hydrolyzed polyacrylonitrile, hydrolyzed polymethacrylonitrile, hydrolyzed acrylonitrile-methacrylonitrile copolymers, and the like.

If included in the enzyme composition, the chelant and/or sequestrant is preferably in a concentration between about 10 ppm and about 10,000 ppm, more preferably between about 25 ppm and about 5,000 ppm, most preferably between about 50 ppm and about 2,500 ppm.

### Alkaline Composition

The alkaline composition preferably comprises an alkali metal hydroxide, alkali metal carbonate, or mixture thereof. Preferred alkali metal hydroxides include sodium hydroxide, potassium hydroxide, or a mixture thereof. Preferred alkali metal carbonates include sodium carbonate, potassium carbonate, or a mixture thereof. In addition to the alkali metal hydroxide and/or alkali metal carbonate, the alkaline composition can optionally further comprise an alkali metal silicate, a metasilicate, sesquicarbonate, organic sources of alkalinity or mixtures thereof.

Organic alkalinity sources are often strong nitrogen bases including, for example, ammonia (ammonium hydroxide), amines, alkanolamines, and amino alcohols. Typical examples of amines include primary, secondary or tertiary amines and diamines carrying at least one nitrogen linked hydrocarbon group, which represents a saturated or unsaturated linear or branched alkyl group having at least 10 carbon atoms and preferably 16-24 carbon atoms, or an aryl, aralkyl, or alkaryl group containing up to 24 carbon atoms, and wherein the optional other nitrogen linked groups are formed by optionally substituted alkyl groups, aryl group or aralkyl groups or polyalkoxy groups. Typical examples of alkanolamines include monoethanolamine, monopropanolamine, diethanolamine, dipropanolamine, triethanolamine, tripropanolamine and the like. Typical examples of amino alcohols include 2-amino-2-methyl-1-propanol, 2-amino-1-butanol, 2-amino-2-methyl-1,3-propanediol, 2-amino-2-ethyl-1,3-propanediol, hydroxymethyl aminomethane, and the like.

The pH of the alkaline composition used in the optional alkalinity step is preferably from about 9.5 to about 12.0, more preferably from about 9.7 to about 11.8, most preferably from about 10.0 to about 11.5.

### Methods of Cleaning a Filtration Membrane

Disclosed herein are methods of cleaning filtration membranes including microfiltration, ultrafiltration, nanofiltration, or reverse osmosis or other membranes or membrane processes, typically utilized in dairy production. Preferably the filtration membranes can be cleaned with a stepwise cleaning regime employing a prerinse step, an optional preclean step, a follow-up rinse step, a detergent step (including enzyme, surfactant and alkalinity or acidic compositions), and rinse step. Alternatively, the filtration membranes can be cleaned with a stepwise cleaning regime employing a prerinse step, an optional preclean step, a follow-up rinse step, an enzyme step, a surfactant step (surfactant and acid step could be combined), a rinse step, an acid step, a rinse step, an optional alkalinity step, and a follow-up rinse step.

Alternatively procedure: preclean step including optionally surfactant, a follow-up rinse step, an enzyme+surfactant step, a rinse step, a acid step, a rinse step, an optional alkalinity step including surfactant, and a follow-up rinse step.

More preferably, the filtration membranes cleaned in the enzyme step 104 are cleaned with an enzyme composition comprising water, an enzyme and a buffer. Most preferably the enzyme composition comprises water, lipase, protease, amylse, buffer, and a chelant. Optionally, also a surfactant could be used in this step.

More preferably, the filtration membranes cleaned in acid step 107 are cleaned with an acidic composition. Most preferably, the acidic composition comprises an acid, an acidic anionic surfactant or a mixture thereof.

More preferably, the filtration membranes cleaned in the alkalinity step 109 are cleaned with an alkaline composition. Most preferably, the alkaline composition comprises an alkali metal hydroxide, alkali metal carbonate, or mixture thereof.

The steps of the methods may contact the filtration membranes from about 1 minute to about 240 minutes, from about 5 minutes to about 180 minutes, from about 15 minutes to about 180 minutes, from about 5 minutes to about 180 minutes, most preferably between about 15 minutes and 180 minutes. In a preferred embodiment, the enzymatic step is for a time between about 1 minute and about 150 minutes, more preferably about 5 minutes to about 140 minutes, still more preferably between about 10 minutes and about 130 minutes; most preferably between about 15 minutes and about 120 minutes. In a preferred embodiment, the surfactant step is for a time between about 1 minute and about 90 minutes, more preferably between about 2 minutes and about 75 minutes, most preferably between about 5 minutes and about 60 minutes.

Beneficially, the compositions and methods disclosed herein provide very good cleaning of the filtration membranes. Preferably, at least about 95% of dairy soil is removed, at least about 98% of dairy soil is removed, at least about 99% of dairy soil is removed, at least about 99.1% of dairy soil is removed, at least about 99.2% of dairy soil is removed, at least about 99.3% of dairy soil is removed, at least about 99.4% of dairy soil is removed, at least about 99.5% of dairy soil is removed, at least about 99.6% of dairy soil is removed, at least about 99.7% of dairy soil is removed, at least about 99.8% of dairy soil is removed, at least about 99.9% of dairy soil is removed.

### Membranes

Disclosed herein are methods of cleaning one or more filtration membranes. The membranes can be microfiltration, ultrafiltration, nanofiltration, and/or reverse osmosis membranes. Microfiltration membranes can include, but are not limited to, Hydranautics SuPro, Synder LX, Synder FR, Alfa Laval GRM 0.1PP, Synder V0.1, Koch Dairy Pro MF-0.1, Alfa Laval FSM0.15, Alfa Laval GRM 0.2PP, Synder V0.2, Alfa Laval FSM0.45. Ultrafiltration membranes can include, but are not limited to, Koch Dairy Pro 5K, Koch HFK-131, Alfa Laval GR61PP, Alfa Laval GR60PP, Synder MK, Alfa Laval GR51PP, Synder MQ, Alfa Laval FS40PP, Synder LY, Synder PY, Synder BY, Koch, HFM-180. Preferably, the filtration membranes are Koch Dairy Pro 5K, Koch HFK-131, Alfa Laval GR61PP, or Alfa Laval GR60PP. The filtration membranes can polymers which include, for example, PES, PS, PVDF, PAN, PA or the like. Preferably, the polymers include PES and PS. The filtration membranes can have an approximate molecular weight cut-off preferably from about 5 kDa to 5000 kDa. The filtration membranes can have an approximate pore size preferably from 0.0005 μm to 0.45 μm.

### Pre-Rinse and Rinse

The membranes are preferably, pre-rinsed in a prerinse step 101. The pre-rinse can remove some soils from the membrane, typically loose soils. Further, during the cleaning process, the membrane is rinsed. Both the pre-rinse and the rinse are preferably performed with water. The water can be tap water or a water that has been softened. The water can have a hardness of about 20 grains or less, preferably about 15 grains or less, more preferably about 10 grains or less, even more preferably 5 grains or less. Most preferably, the water is distilled water or RO (reverse osmosis) water. The rinse water can be any temperature for which the membrane is compatible. Thus, tap water can be used, room temperature water can used, or heated water can be used so long as it does not exceed the temperature guidelines for the particular membrane. For most membranes, this will be up to 50° C. For high temperature membranes, this can be up to 60° C. or even up to 70° C. For a standard membrane, preferably the temperature of the rinse water is between 20° C. and 50° C., more preferably between 25° C. and 50° C., most preferably between 30° C. and 50° C. for a high temperature membrane, preferably the temperature of the rinse water is between 20° C. and 70° C., more preferably between 25° C. and 70° C., most preferably between 30° C. and 70° C.

### Optional Preclean

Optionally, a membrane can be pre-cleaned with a membrane cleaning detergent in an optional preclean step 102. A membrane cleaning detergent can aid in removing some of the easier to clean soils from the membrane thereby allowing the methods disclosed herein to focus more on the difficult soils. Any suitable membrane cleaning detergent can be employed.

If a preclean step is performed, then a follow-up rinse 103 is performed to remove the membrane cleaning detergent. The rinse is preferably performed with water. The water can be tap water or a water that has been softened. The water can have a hardness of about 20 grains or less, preferably about 15 grains or less, more preferably about 10 grains or less, even more preferably 5 grains or less. Most preferably, the water is distilled water or RO (reverse osmosis) water. The rinse water can be any temperature for which the membrane is compatible. Thus, tap water can be used, room temperature water can used, or heated water can be used so long as it does not exceed the temperature guidelines for the particular membrane. For most membranes, this will be up to 50° C. For high temperature membranes, this can be up to 60° C. or even up to 70° C. For a standard membrane, preferably the temperature of the rinse water is between 20° C. and 50° C., more preferably between 25° C. and 50° C., most preferably between 30° C. and 50° C. for a high temperature membrane, preferably the temperature of the rinse water is between 20° C. and 70° C., more preferably between 25° C. and 70° C., most preferably between 30° C. and 70° C.

### Detergent Step

The membrane is contacted with a multi-part detergent system. This can be in a single-pot solution or stepwise as set forth above. The multi-part detergent system comprises an enzyme composition, surfactant booster, and alkalinity composition. The pH of the enzyme composition is preferably from about 7.5 to about 11.0, more preferably from about 8.0 to about 10.5, most preferably from about 9 to about 10. The t

The temperature of the detergent can be any temperature for which the membrane is compatible. For most membranes, this will be up to 50° C. For high temperature membranes, this can be up to 60° C. or even up to 70° C. For a standard membrane, preferably the temperature of the rinse water is between 20° C. and 50° C., more preferably between 25° C. and 50° C., most preferably between 30° C. and 50° C. for a high temperature membrane, preferably the temperature of the rinse water is between 20° C. and 70° C., more preferably between 25° C. and 70° C., most preferably between 30° C. and 70° C.

### PREFERRED EMBODIMENTS

The present disclosure is further defined by the following numbered embodiments:

1. A low toxicity surfactant booster composition for filtration membrane cleaning comprising: from about 2% active to about 30% active of an C₄-C₂₄ alkyl polyglycoside; from about 5% active to about 60% active of an alkoxylated block copolymer; and from about 10 wt. % to about 70 wt. % water; wherein the surfactant booster composition has soil penetration efficacy against dairy soils comprising fats and proteins.

2. The composition of embodiment 1, wherein alkyl polyglycoside is a C₈-C₁₆ alkyl polyglycoside.

3. The composition of embodiment 1 or 2, wherein the alkyl polyglycoside is in a concentration of from about 2% active to about 20% active; or wherein the alkyl polyglycoside is in a concentration of from about 5% active to about 20% active.

4. The composition of any one of embodiments 1-3, wherein the alkoxylated block copolymer is an EO-PO block copolymer, a reverse block copolymer, or a mixture thereof.

5. The composition of any one of embodiments 1-4, wherein the alkoxylated block copolymer is an EO-PO-EO block copolymer.

6. The composition of any one of embodiments 1-5, wherein the alkoxylated block copolymer is in a concentration of from about 10% active to about 55% active; or wherein the alkoxylated block copolymer is in a concentration of from about 15% active to about 50% active.

7. The composition of any one of embodiments 1-6, further comprising a chelant and/or sequestrant.

8. The composition of embodiment 7, wherein chelant and/or sequestrant is an aminocarboxylate.

9. The composition of any one of embodiments 1-8, wherein further comprising an enzyme.

10. The composition of embodiment 9, wherein the enzyme comprises an amylase, a cellulase, a lipase, a protease, a cutinase, a peroxidase, a gluconase, a DNAse, or a mixture thereof.

11. The composition of any one of embodiments 1-10, further comprising an alkalinity source or an acid source.

12. A method of cleaning a filtration membrane comprising:
(a) contacting the filtration membrane with the surfactant booster composition of any one of embodiments 1-11; and (b) rinsing the filtration membrane.

13. The method of embodiment 12, wherein the filtration membrane comprises a microfiltration membrane, an ultrafiltration membrane, nanofiltration membrane, and/or a reverse osmosis membrane.

14. The method of embodiment 12 or 13, further comprising pre-rising the filtration membrane prior to the contacting step (a).

15. The method of any one of embodiments 12-14, wherein the contacting step (a) further comprises contacting the filtration membrane with an enzyme composition and/or alkalinity composition.

16. The method of embodiment 15, wherein the enzyme composition comprises a lipase, a protease, and a buffer.

17. The method of any one of embodiments 13-16, further comprising
(c) contacting the filtration membrane with an acidic composition after the rinsing step and (d) rinsing the filtration membrane.

18. The method of any one of embodiments 12-17, further comprising diluting the surfactant booster composition with water before the contacting step (a).

19. The method of embodiment 18, wherein the surfactant booster composition is diluted to a concentration of less than about 1,000 ppm.

20. The method of embodiment 19, wherein the surfactant booster composition is diluted to a concentration of less than about 500 ppm.

### EXAMPLES

Embodiments of the present disclosure are further defined in the following non-limiting Examples. It should be understood that these Examples, while indicating certain embodiments of the disclosure, are given by way of illustration only. From the above discussion and these Examples, one skilled in the art can ascertain the essential characteristics of this disclosure, and without departing from the spirit and scope thereof, can make various changes and modifications of the embodiments of the disclosure to adapt it to various usages and conditions. Thus, various modifications of the embodiments of the disclosure, in addition to those shown and described herein, will be apparent to those skilled in the art from the foregoing description. Such modifications are also intended to fall within the scope of the appended claims.

The following materials were utilized in the Examples:
Nonylphenol ethoxylate (NPE)
Linear alcohol ethoxylate
Guerbet alcohol ethoxylate
Ethoxylated propoxylated 2-ethyl-hexanol (i.e., EH9)
Alkyl polyglucosides (APGs)
EO/PO block copolymers
C9-11 linear alcohol

The following materials are available from commercial suppliers, including, but not limited to BASF and Solvay:
C₈-C₁₄ APGs,
alkoxylated block copolymers having an average molecular weight between about 2000 and about 3000 with from about 20% moles ethoxylation to about 40% moles ethoxylation

Commodity or widely commercially available materials: deionized water.

### Example 1

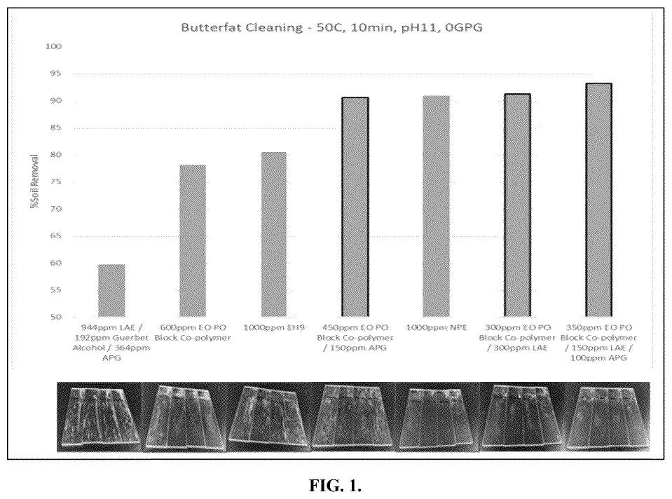

The cleaning properties of example block copolymers as well as block copolymer/APG combinations were evaluated against competitive surfactants under alkaline conditions, as shown in FIG. 1.

Surfactants were screened for lower toxicity levels. Conventional surfactant NPE has a DNEL of less than about 1 while conventional surfactant EH9 has a DNEL of less than about 5. On the other hand, the APGs and EO/PO block copolymers have relatively low toxicity with a DNEL of greater than about 20. Given these relative toxicities, utilizing APG and/or EO/PO block copolymer surfactants instead of NPE reduces the risk profile of the composition by at least 100-fold.

As shown in FIG. 1, the block copolymer surfactant maintains relatively low toxicity and has excellent cleaning properties even at low concentrations (<1000 ppm) under alkaline conditions. It was observed during the bench top cleaning that soil would collect near the top of the coupons and redeposit onto it. This led to adding an APG to aid in soil removal, prevent redeposition, while maintaining low toxicity.

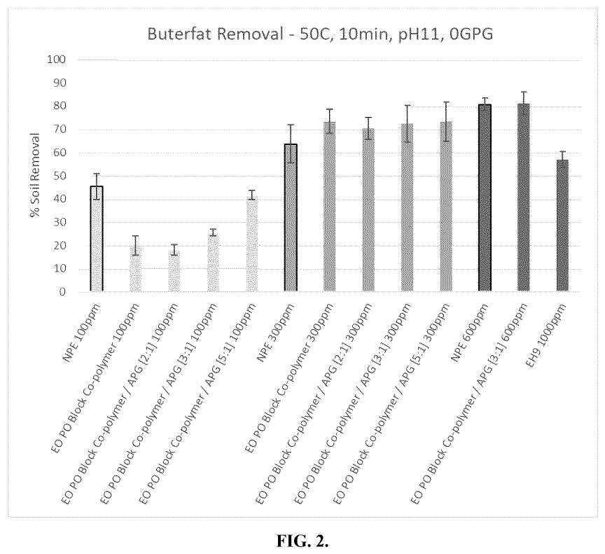

The cleaning properties of block copolymers, combinations of block copolymers and APGs, and other comparable surfactants were evaluated at lower doses and shown in FIG. 2. The coupon staging area was prepared by lining a cookie sheet with a layer of Wypall towels. Each coupon was soaked in methanol for 30 seconds and allowed to dry. The coupons were placed on a prepared cookie sheet in a 120° F. oven for 30 minutes. Further, the cookie sheet was covered to prevent other projects in the oven from contaminating the coupons. Coupons were labeled with Sharpie markings for identification purposes. The clean, dry coupons were weighed and recorded on an analytical balance. Coupons were soiled with a homogenous layer of unsalted butter (0.0250-0.0300 g) through application by a 1″ wide foam brush, with 25% of the coupon kept unsoiled. Coupons were allowed to dry overnight after soiling and were weighed and recorded the next day. The block copolymer and APG at 300 ppm and 600 ppm were found to outperform inline formulation (EH9) at 1000 ppm.

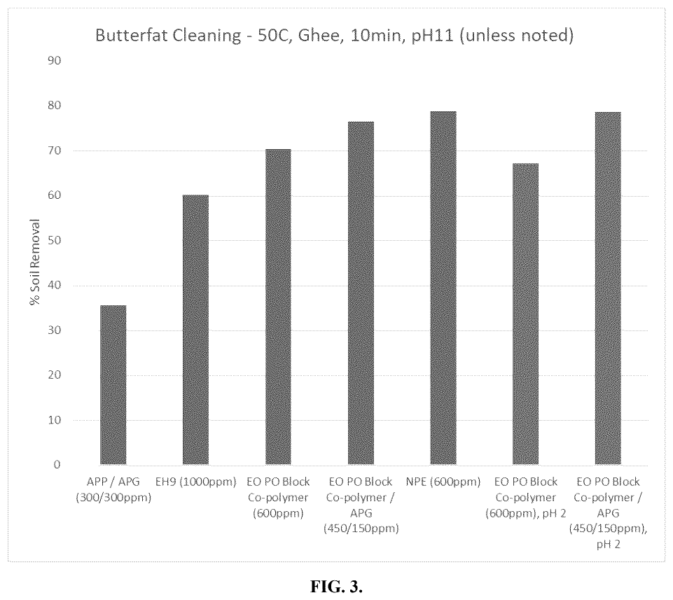

Additional experimentation of block copolymers, combinations of block copolymers and APGs, and other comparable surfactants was conducted and displayed in FIG. 3. Furthermore, additional experimentation was conducted to assess possible surfactant use under acidic conditions. The block copolymers alone and in combination with APG maintain performance in the presence of acid. Notably, these compounds maintained such performance despite a lower dose than inline formulas (EH9).

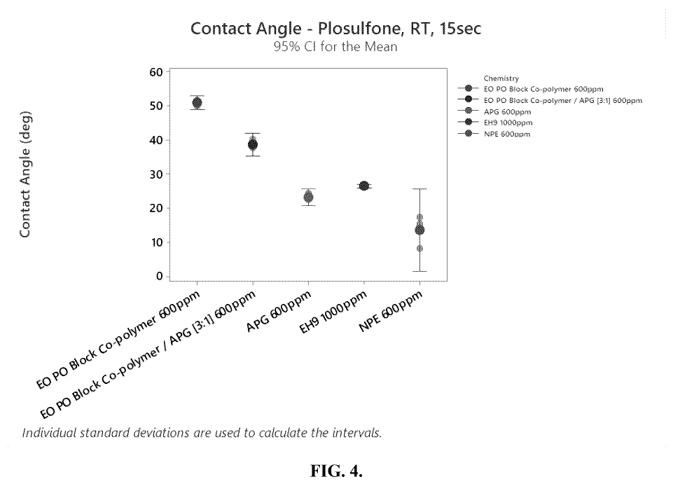

Wettability comparisons between block copolymers, APGs, combinations thereof, and inline formulas were drawn in FIG. 4. Coupons were initially cleaned for 30 seconds in methanol. Coupons were left to dry for 30 minutes at 50-60° C. and cooled to room temperature. Desired test solutions were mixed using DI water. Optical tensiometer was calibrated, and the focus was optimized prior to sample running. Contact angles were run on the clean coupons using test solutions in the liquid phase. Samples consisted of 4 μL drop sizes with a minimum of three drops per test solution. Samples were run at room temperature for 20 seconds or longer. The average of the mean for all drops was obtained and analyzed. Notably, the contact angle of the block copolymer was lowered when combined with an APG species.

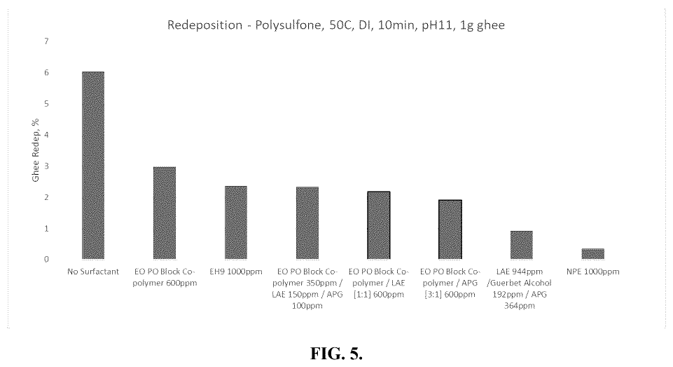

Redeposition of ghee onto coupons for block copolymers, APGs, combinations thereof, and inline formulas was reported in FIG. 5. Each coupon was new and conditioned by soaking in methyl alcohol for 30 seconds, then placed in 60° C. oven for 30 minutes. 600 g of 0 grain water was heated in a 1000 ml beaker to 50° C. The pH of the mixture was adjusted to 11 using NaOH. The chemistry was added to the solution and mixed for one minute. Additionally, 1 g of melted ghee was added to the solution and mixed for one minute. Three cleaned and weighed coupons were added using a coupon holder. After 10 minutes, the coupons were removed and dipped in DI water once. Coupons were left to dry overnight and weighed the following day. The addition of an APG helps prevent a larger amount of butterfat from being deposited onto the coupons. Therefore, after the soil is removed it is less likely to be redeposited onto the surface again.

The disclosure being thus described, it will be obvious that the same may be varied in many ways. Such variations are not to be regarded as a departure from the spirit and scope of the disclosures and all such modifications are intended to be included within the scope of the following claims. The above specification provides a description of the manufacture and use of the disclosed compositions and methods. Since many embodiments can be made without departing from the spirit and scope of the disclosure, the invention resides in the claims.

What is claimed is:

1. A low toxicity surfactant booster composition for filtration membrane cleaning comprising:
from about 2% active to about 30% active of an C₄-C₂₄ alkyl polyglycoside;
from about 5% active to about 60% active of an alkoxylated block copolymer; and
from about 20 wt. % to about 70 wt. % water;
wherein the surfactant booster composition has soil penetration efficacy against dairy soils comprising fats and proteins.

2. The composition of claim 1, wherein alkyl polyglycoside is a C₈-C₁₆ alkyl polyglycoside.

3. The composition of claim 2, wherein the alkyl polyglycoside is in a concentration of from about 2% active to about 20% active.

4. The composition of claim 1, wherein the alkoxylated block copolymer is an EO-PO block copolymer, a reverse block copolymer, or a mixture thereof.

5. The composition of claim 4, wherein the alkoxylated block copolymer is an EO-PO-EO block copolymer.

6. The composition of claim 5, wherein the alkoxylated block copolymer is in a concentration of from about 15% active to about 60% active.

7. The composition of claim 1, further comprising a chelant and/or sequestrant.

8. The composition of claim 7, wherein the chelant and/or sequestrant is an aminocarboxylate.

9. The composition of claim 1, further comprising an enzyme.

10. The composition of claim 9, wherein the enzyme comprises an amylase, a cellulase, a lipase, a protease, a cutinase, a peroxidase, a gluconase, a DNAse, or a mixture thereof.

11. The composition of claim 1, further comprising an alkalinity source or an acid source.

12. A method of cleaning a filtration membrane comprising:
(a) contacting the filtration membrane with the surfactant booster composition comprising from about 2% active to about 30% active of an C₄-C₂₄ alkyl polyglycoside; from about 5% active to about 60% active of an alkoxylated block copolymer; and from about 20 wt. % to about 70 wt. % water;
(b) rinsing the filtration membrane.

13. The method of claim 12, wherein the filtration membrane comprises a microfiltration membrane, an ultrafiltration membrane, nanofiltration membrane, and/or a reverse osmosis membrane.

14. The method of claim 13, further comprising pre-rising the filtration membrane prior to the contacting step (a).

15. The method of claim 12, wherein the contacting step (a) further comprises contacting the filtration membrane with an enzyme composition and/or alkalinity composition.

16. The method of claim 15, wherein the enzyme composition comprises a lipase, a protease, and a buffer.

17. The method of claim 12, further comprising
(c) contacting the filtration membrane with an acidic composition and
(d) rinsing the filtration membrane.

18. The method of claim 12, further comprising diluting the surfactant booster composition with water to form a use solution comprising about 5 ppm to about 10,000 ppm of the C₄-C₂₄ alkyl polyglycoside and about 10 ppm to about 10,000 ppm of the alkoxylated block copolymer before the contacting step (a).

19. The method of claim 18, wherein the surfactant booster composition is diluted to a concentration of less than about 1,000 ppm.

20. The method of claim 19, wherein the surfactant booster composition is diluted to a concentration of less than about 500 ppm.
